(19) United States
(12) Patent Application Publication
(10) Pub. No.: US 2015/0309371 A1
(43) Pub. Date: Oct. 29, 2015

(54) LIQUID CRYSTAL DISPLAY PANEL AND MANUFACTURING METHOD USING THE SAME

(71) Applicant: AU Optronics Corporation, HSIN-CHU (TW)

(72) Inventors: Shih-Ming CHEN, HSIN-CHU (TW); Chieh-Hsien LIN, HSIN-CHU (TW); Chih-Hsiang TSENG, HSIN-CHU (TW); Tai-Hua LEE, HSIN-CHU (TW); Chia-Hsuan PAI, HSIN-CHU (TW)

(21) Appl. No.: 14/330,216

(22) Filed: Jul. 14, 2014

(30) Foreign Application Priority Data
Apr. 23, 2014 (TW) 103114711

(51) Int. Cl. G02F 1/1337

(52) U.S. Cl. CPC G02F 1/133784; G02F 1/133711; G02F 1/133788

(57) ABSTRACT

A method for manufacturing a liquid crystal display panel includes respectively forming two polymer layers on a first substrate and a second substrate. The two polymer layers are rubbed. A plurality of liquid crystal molecules and a plurality of monomers are provided between the first substrate and the second substrate, and the polymer layers are disposed facing the liquid crystal molecules and the monomers. The monomers are polymerized to form two polymer rubbing layers with the polymer layers.

### RELATED APPLICATIONS

This application claims priority to Taiwan Application Serial Number 103114711, filed Apr. 23, 2014, which is herein incorporated by reference.

### BACKGROUND

1. Field of Invention

The present invention relates to a liquid crystal display panel.

2. Description of Related Art

In recent years, the liquid crystal display panel market has been promoted due to emergence of new photovoltaic technologies and the arrival of the digital era. Liquid crystal display panels have advantages such as high resolution, relatively small-size, low driving voltages, and low energy consumption, thus are widely applied in consumer communications or found in other electronic products such as personal digital assistants (PDAs), cell phones, cameras, notebooks, desktop displays, car displays, TVs, and so on.

In general, rubbing layers can be included in the liquid crystal display panel to align the liquid crystal molecules in the panel along specific directions. The rubbing layers can align the liquid crystal molecules which are electrically undriven. The liquid crystal molecules can lie in the grooves of the rubbing layers, thus they can be arranged along the same direction. However, the rubbing layers may be polluted or there may be a leak of anchoring force depending on the manufacturing process, and many in the industry are striving to improve the problems mentioned above.

### SUMMARY

An aspect of the present invention is to provide a method for manufacturing a liquid crystal display panel including respectively forming two polymer layers on a first substrate and a second substrate. The two polymer layers are rubbed. A plurality of liquid crystal molecules and a plurality of monomers are provided between the first substrate and the second substrate. The polymer layers are disposed facing the liquid crystal molecules and the monomers. The monomers are polymerized to form two polymer rubbing layers with the polymer layers.

In one or more embodiments, the method further includes controlling a mean surface roughness of the polymer rubbing layers to satisfy:

22.33 nm≦Rms≦48.55 nm, where Rms is the mean surface roughness of the polymer rubbing layers.

Another aspect of the present invention is to provide a liquid crystal display panel including a first substrate, a second substrate, a liquid crystal layer, and two polymer rubbing layers. The second substrate is disposed opposite to the first substrate. The liquid crystal layer is disposed between the first substrate and the second substrate. The liquid crystal layer includes a plurality of liquid crystal molecules. Each of the liquid crystal molecules has a pretilt angle satisfying: 1°≦θ≦2°, where θ is the pretilt angle. The polymer rubbing layers are respectively disposed between the first substrate and the liquid crystal layer, and between the second substrate and the liquid crystal layer. A mean surface roughness of surfaces of the two polymer rubbing layer facing the liquid crystal layer satisfies:

22.33 nm≦Rms≦48.55 nm, where Rms is the mean surface roughness of the surfaces of the polymer rubbing layers.

### BRIEF DESCRIPTION OF THE DRAWINGS

FIGS. 1-3, 4A, and 5A are cross-sectional views of a method for manufacturing a liquid crystal display panel at different stages according to one embodiment of the present invention;

FIG. 4B is a top view of the liquid crystal molecules, the monomers, and the polymer layer of FIG. 4A;

FIG. 5B is a top view of a polymer rubbing layer of FIG. 5A; and

FIG. 6 is a side view of a liquid crystal display panel according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

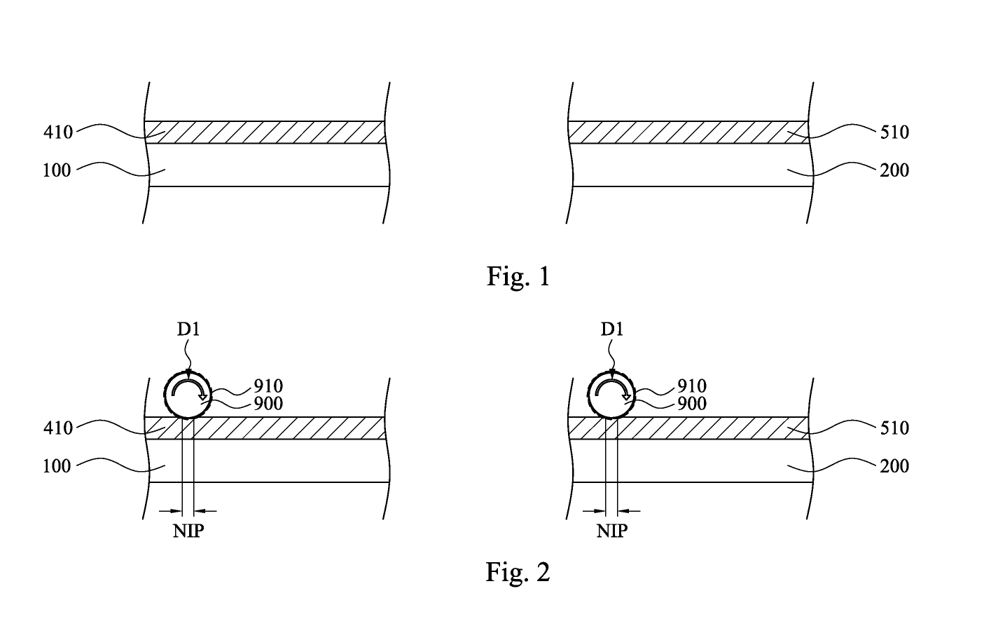

FIGS. 1-3, 4A, and 5A are cross-sectional views of a method for manufacturing a liquid crystal display panel at different stages according to one embodiment of the present invention. Reference is made to FIG. 1. A polymer layer 410 is formed on the first substrate 100, and a polymer layer 510 is formed on the second substrate 200. The first layer 100 can be an active device substrate, and the second substrate 200 can be an opposite substrate including color filters. However, in other embodiments, the first substrate 100 can be a color filter on array (COA) substrate, and the second substrate 200 can be a transparent substrate such as a glass substrate, and the claimed scope is not limited in this respect. The polymer layers 410 and 510 can be made from polyamide.

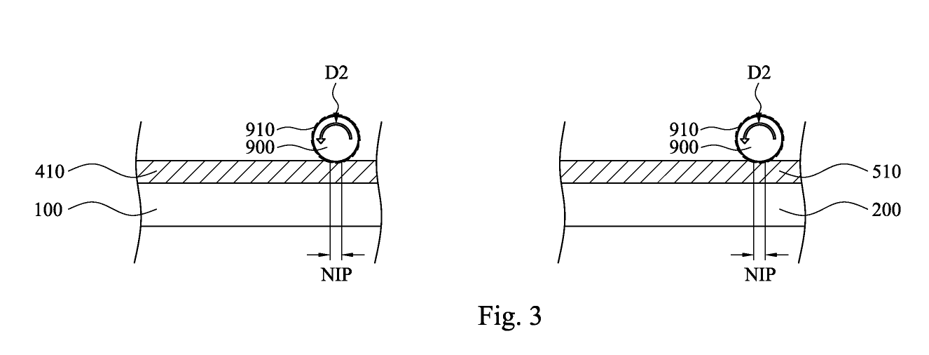

Reference is made to FIGS. 2 and 3. Subsequently, the polymer layers 410 and 510 can be rubbed. In this embodiment, a roller 900 can be used to rub the polymer layers 410 and 510, and the roller 900 can sequentially rotate along a first direction D1 (see FIG. 2) and a second direction D2 (see FIG. 3) to rub the polymer layers 410 and 510, where the first direction D1 is opposite to the second direction D2. In greater detail, a plurality of fibers 910 can be formed at the side surface of the roller 900. In the rubbing process of FIG. 2, the roller 900 can first rotate along the first direction D1 (for example, clockwise direction) to evenly rub the polymer layers 410 and 510. Then, in the rubbing process of FIG. 3, the roller 900 can rotate along the second direction D2 (for example, counterclockwise direction) to evenly rub the polymer layers 410 and 510. Therefore, there is an improvement in uniformity of the rubbed layers.

Moreover, in this embodiment, since the roller 900 rubs each of the polymer layers 410 and 510 twice, it may increase the amount of dust or the fibers 910 dropping on the polymer layers 410 and 510 from the roller 900. One method of improvement is to reduce the pressure of the roller 900 pressing on the polymer layers 410 and 510. For example, the contact area between the roller 900 and each of the polymer layers 410 and 510 is reduced during the rubbing process, where the contact area is proportional to the pressure. Since the roller 900 is cylindrical, the contact area is proportional to a contact width NIP marked in FIGS. 2 and 3. In a regular rubbing process, the contact width NIP is about 14 mm. In contrast, in this embodiment, the contact width NIP can be reduced to about 8 mm to reduce the amount of dust or the fibers 910 dropping on the polymer layers 410 and 510.

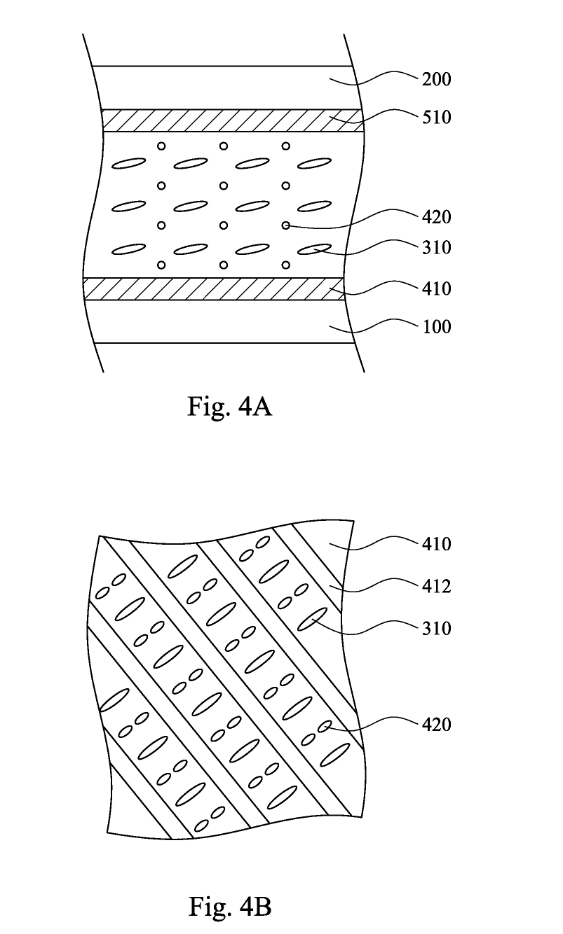

FIG. 4B is a top view of the liquid crystal molecules 310, the monomers 420, and the polymer layer 410 of FIG. 4A. Reference is made to FIGS. 4A and 4B. Subsequently, a plurality of liquid crystal molecules 310 and a plurality of monomers 420 are provided between the first substrate 100 and the second substrate 200, and the polymer layers 410 and 510 are disposed facing the liquid crystal molecules 310 and the monomers 420. In this embodiment, the liquid crystal molecules 310 and the monomers 420 can be filled between the first substrate 100 and the second substrate 200 using one drop fill (ODF) process, and the claimed scope is not limited in this respect.

Moreover, both of the polymer layers 410 and 510 have rubbing grooves (such as rubbing grooves 412 in FIG. 4B) after the rubbing processes of FIGS. 2 and 3. Therefore, the liquid crystal molecules 420 can be aligned in the rubbing grooves 412 when they are filled between the first substrate 100 and the second substrate 200. In addition, since the monomers 420 are restricted by the liquid crystal molecules 310, they are distributed between the liquid crystal molecules 310. In other words, the monomers 420 have specific arrangement directions due to the liquid crystal molecules 310.

In this embodiment, the monomers 420 can be photopolymerizable materials. That is, the monomers 420 can be polymerized to be polymers after being illuminated.

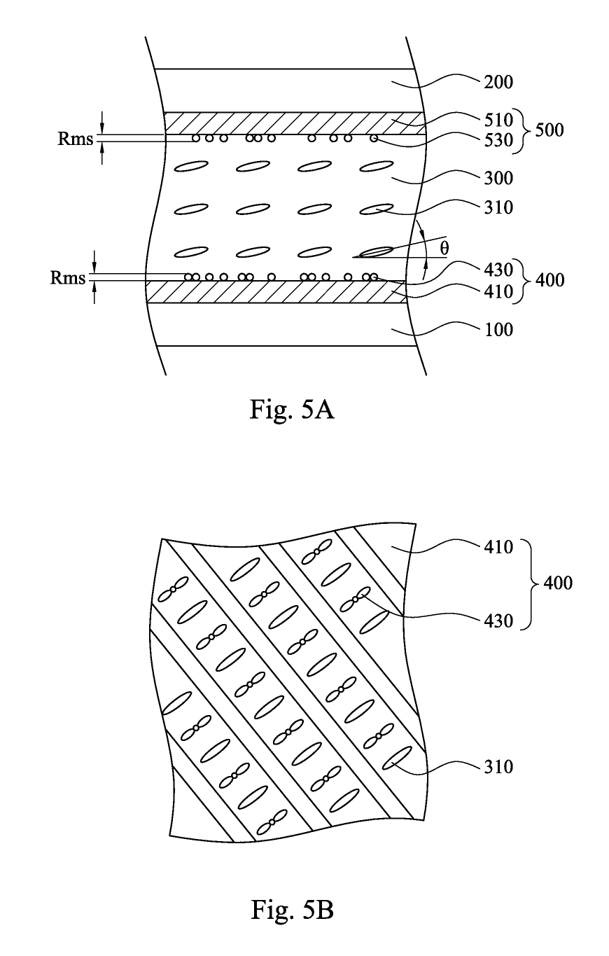

FIG. 5B is a top view of a polymer rubbing layer 400 of FIG. 5A. Reference is made to FIGS. 5A and 5B. Subsequently, the monomers 420 in FIG. 4A are polymerized to form two polymer rubbing layers 400 and 500 with the polymer layers 410 and 510. In greater detail, an illuminating process, such as an ultraviolet illuminating process, can be performed upon the monomers 420. Thus, the monomers 420 are polymerized to be polymers 430 and 530 after being illuminated, and the polymers 430 and 530 are respectively fixed on the polymer layers 410 and 510 to form the polymer rubbing layers 400 and 500. The polymers 430 and 530 are photopolymerized materials, and the manufacturing process of the liquid crystal display panel is complete.

During the manufacturing process of FIG. 4B, since the monomers 420 have specific arrangement directions, which are substantially the same as the arrangement direction of the liquid crystal molecules 310, after the monomers 420 are polymerized, the polymers 430 and 530 are respectively fixed on the polymer layers 410 and 510 with the aforementioned arrangement directions of the monomers 420, thus contributing the alignment of the liquid crystal molecules 310. As a result, during the rubbing process as shown in FIGS. 2 and 3, even through the roller 900 (see FIG. 2) presses the polymer layers 410 and 510 with such a small pressure that makes a weak anchoring force in the polymer layers 410 and 510, the polymers 430 and 530 can provide extra anchoring force when the polymer rubbing layers 400 and 500 are formed to compensate the whole anchoring force of the polymer rubbing layers 400 and 500.

In one or more embodiments, a mean surface roughness Rms of the polymer rubbing layers 400 and 500 can be controlled to satisfy:

22.33 nm≦Rms≦48.55 nm, where the controlling method can be adjusting the polymerizing time of the monomers 420 (see FIG. 4A) or providing different amounts of the monomers 420, and the claimed scope of the present invention is not limited in this respect. In addition, adjusting the polymerizing time of the monomers 420 may be adjusting the illumination time of the monomers 420.

In greater detail, the mean surface roughness Rms of the polymer rubbing layers 400 and 500 is proportional to the amounts of the polymers 430 and 530. That is, the mean surface roughness Rms increases as the amounts of the polymers 430 and 530 increase, and the rubbing property is better. In an example, the measured anchoring force of the polymer rubbing layers 400 and 500 were 10.48×10⁻³ J/m² when the contact width NIP of FIGS. 2 and 3 was 8 mm and the mean surface roughness Rms of FIG. 5A was 22.33 nm. Moreover, the polymer layers 410 and 510 without the polymers 430 and 530 had a measured anchoring force 10.36×10⁻³ J/m² when the contact width NIP was 14 mm. Therefore, these two examples prove the polymers 430 and 530 polymerized from the monomers 420 contribute extra anchoring force.

In another example, the measured anchoring force of the polymer rubbing layers 400 and 500 were 18.7×10⁻³ J/m² when the contact width NIP was 8 mm and the mean surface roughness Rms was 44.55 nm. The driving voltage of liquid crystal molecules in this example was about 1 volt higher than that of the liquid crystal display panel pressed with 14 mm contact width NIP and without monomers 420. In greater detail, the anchoring force increases as the mean surface roughness Rms increases, resulting in an increase of the driving voltage of the liquid crystal molecules 310, where the driving voltage herein is a voltage that turns the liquid crystal layer 300 from a dark state to a white state. However, as mentioned above, merely about 1 volt increase of the driving voltage, the liquid crystal display panel in this example had similar optical performance as the liquid crystal display panel without the polymers 420. For example, the transmittance of the liquid crystal layer 300 in this example was about 100% at the white state, which proved the switch between the white/dark states of the liquid crystal layer 300 was not severely affected when the mean surface roughness Rms≦48.55 nm.

Reference is made to FIGS. 5A and 5B. From the structural point of view, the liquid crystal display panel includes the first substrate 100, the second substrate 200, the liquid crystal layer 300, and the two polymer rubbing layers 400 and 500. The second substrate 200 is disposed opposite to the first substrate 100. The liquid crystal layer 300 is disposed between the first substrate 100 and the second substrate 200. The liquid crystal layer 300 includes a plurality of liquid crystal molecules 310. Each of the liquid crystal molecules 310 has the pretilt angle θ satisfying: 1°≦θ≦2°. The polymer rubbing layer 400 is disposed between the first substrate 100 and the liquid crystal layer 300, and the polymer rubbing layer 500 is disposed between the second substrate 200 and the liquid crystal layer 300. A mean surface roughness Rms of surfaces of the two polymer rubbing layer 400 and 500 facing the liquid crystal layer 300 satisfies:

22.33 nm≦Rms≦48.55 nm.

In this embodiment, the polymer rubbing layer 400 (500) includes the polymer layer 410 (510) and a plurality of the polymers 430 (530). The polymers 430 (530) are distributed on the surface of the polymer layer 410 (510) facing the liquid crystal layer 300 to provide extra anchoring force to the liquid crystal molecules 310 of the liquid crystal layer 300.

The pretilt angle θ of the liquid crystal molecules 310 satisfies 1°≦θ≦2° if the polymer rubbing layers 400 and 500 are rubbed. This pretilt angle θ can be applied to the liquid crystal display panels using a fringe field switching (FFS) technique. The following examples provide details about the polymers 430 and 530 affecting the pretilt angle θ of the liquid crystal molecules 310. Reference is made to Table 1. The contact width NIP (see FIG. 2) of panel 1 was 14 mm, and the polymers 430 and 530 were absent in the panel 1. The contact width NIP of panel 2 was 8 mm, the polymers 430 and 530 were added in the panel 2, and the mean surface roughness Rms (see FIG. 5A) was 22.33 nm. The pretilt angles θ of the panels 1 and 2 are measured 5 times. The results indicate the pretilt angles θ of the panels 1 and 2 are approximately the same, which proved the polymer rubbing layers 400 and 500 do not severely affect the pretilt angle θ of the liquid crystal molecules 310.

TABLE 1
Pretilt angles θ of different panels

| | Pretilt Angle θ | | Pretilt Angle θ | |
|---|---|---|---|---|
| | First Substrate | Average | Second Substrate | Average |
| | 100 | Value | 200 | Value |
| Panel 1 | 1.918 | 1.929 | 1.995 | 1.994 |
| | 1.988 | | 2.058 | |
| | 1.868 | | 1.943 | |
| | 1.932 | | 1.969 | |
| | 1.939 | | 2.005 | |
| Panel 2 | 1.796 | 1.8224 | 2.001 | 1.999 |
| | 1.779 | | 2.034 | |
| | 1.87 | | 2.021 | |
| | 1.814 | | 1.944 | |
| | 1.853 | | 1.995 | |

In summary, a roller is used to rub the polymer layers of the liquid crystal display panel of the present embodiment back and forth to improve the uniformity of rubbing performance. Reduced pressures of the roller pressing on the polymer layer reduce the amounts the dust and the fibers dropping on the polymer layers. The weak anchoring force due to the reduced pressure can be compensated for by the anchoring force provided by the polymers. In addition, the polymer rubbing layers do not severely affect the pretilt angles of the liquid crystal molecules. In other words, the liquid crystal display panel of the present embodiment has a high rubbing uniformity, low pollution of unwanted fibers upon the rubbing layers, and has a high anchoring force.

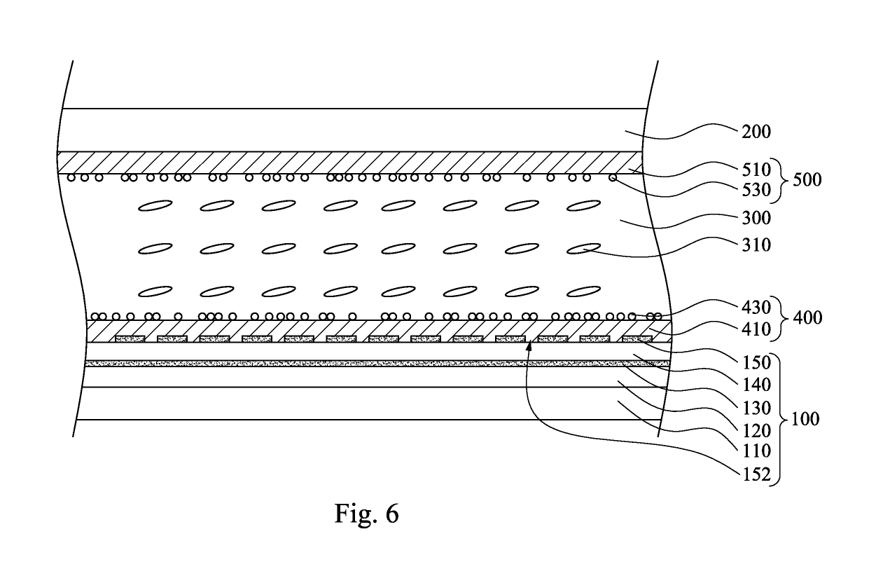

FIG. 6 is a side view of a liquid crystal display panel according to another embodiment of the present invention. The difference between the present embodiment and the embodiment of FIG. 5A pertains to the structure of the first substrate 100. In this embodiment, the first substrate 100 is a fringe field switching (FFS) active device substrate. More specifically, the first substrate 100 includes a base 110, a passivation layer 120, a first transparent electrode 130, a dielectric layer 140, and a second transparent electrode 150. The passivation layer 120 is disposed on the base 110, the first transparent electrode 130 is disposed on the passivation layer 120, the dielectric layer 140 is disposed on the first transparent electrode 130, the second transparent electrode 150 is disposed on the dielectric layer 140, and the polymer rubbing layer 400 is disposed on the second transparent electrode 150. In one embodiment, the first transparent electrode 130 is a common electrode, and the second transparent electrode 150 is a pixel electrode, or the first transparent electrode 130 is a pixel electrode, and the second transparent electrode 150 is a common electrode. In addition, the second transparent electrode 150 may have a plurality of openings 152, such that a horizontal electric field can be formed in the liquid crystal layer 300 when voltages are applied to the first transparent electrode 130 and the second transparent electrode 150. Other relevant structural details of the present embodiment are all the same as the embodiment of FIG. 5A, and, therefore, a description in this regard will not be repeated hereinafter.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for manufacturing a liquid crystal display panel, comprising:
respectively forming two polymer layers on a first substrate and a second substrate;
rubbing the two polymer layers;
providing a plurality of liquid crystal molecules and a plurality of monomers between the first substrate and the second substrate, and the polymer layers being disposed facing the liquid crystal molecules and the monomers; and
polymerizing the monomers to form two polymer rubbing layers with the two polymer layers.

2. The method of claim 1, further comprising:
controlling a mean surface roughness of the polymer rubbing layers to satisfy:
22.33 nm≦Rms≦48.55 nm, wherein Rms is the mean surface roughness of the polymer rubbing layers.

3. The method of claim 2, wherein controlling the mean surface roughness comprises adjusting a polymerizing time of the monomers.

4. The method of claim 1, wherein polymerizing the monomers comprises performing an illuminating process to the monomers.

5. The method of claim 4, wherein the illuminating process is an ultraviolet illuminating process.

6. The method of claim 1, wherein the monomers are made from photopolymerizable materials.

7. The method of claim 1, wherein rubbing the two polymer layers comprises rubbing the two polymer layers with a roller, the roller rubs each of the polymer layers sequentially along a first direction and a second direction opposite to each other.

8. A liquid crystal display panel, comprising:
a first substrate;
a second substrate disposed opposite to the first substrate;
a liquid crystal layer disposed between the first substrate and the second substrate, the liquid crystal layer comprising a plurality of liquid crystal molecules, each of the liquid crystal molecules having a pretilt angle satisfying: 1°≦θ≦2°, wherein θ is the pretilt angle; and
two polymer rubbing layers respectively disposed between the first substrate and the liquid crystal layer, and between the second substrate and the liquid crystal layer, wherein a mean surface roughness of surfaces of the two polymer rubbing layer facing the liquid crystal layer satisfies:
22.33 nm≦Rms≦48.55 nm,
wherein Rms is the mean surface roughness of the surfaces of the polymer rubbing layers.

9. The liquid crystal display panel of claim 8, wherein each of the polymer rubbing layers comprises:
a polymer layer; and
a plurality of polymer molecules distributed on a surface of the polymer layer facing the liquid crystal layer.

10. The liquid crystal display panel of claim 8, wherein the first substrate is a fringe field switching (FFS) active device substrate.
